(19) United States
(12) Patent Application Publication
(10) Pub. No.: US 2004/0213702 A1
(43) Pub. Date: Oct. 28, 2004

(54) Layered composite and micromechanical sensor element, in particular gas sensor element having said layered composite

(76) Inventor: Kurt Ingrisch, Reutlingen (DE)

Correspondence Address: Striker Striker & Stenby, 103 East Neck Road, Huntington, NY, 11743, US

(21) Appl. No.: 10/483,134

(22) PCT Filed: Jun. 4, 2002
(86) PCT No.: PCT/DE02/02024

(30) Foreign Application Priority Data
Jul. 10, 2001 (DE) 101 33 466.4

(51) Int. Cl. G01N 27/00

(52) U.S. Cl. 422/98; 422/94

(57) ABSTRACT

A layered composite with a gas-sensitive layer (15) and a catalytically active layer (16), joined materially to it at least in some regions, is provided, in which the gas-sensitive layer (15) has a first material and the catalytically active layer (16) has both the first material and a catalytically active additive. It is also provided that the specific electrical resistance of the catalytically active layer (16) is higher than that of the gas-sensitive layer (15). In addition, a micromechanical sensor element (5), in particular a gas sensor element, with a dielectric layer (11), a gas-sensitive layer (15) disposed on the dielectric layer, and means (14) for detecting a change in the electrical conductivity of the gas-sensitive layer (15) under the influence of a gas is proposed. It is provided that the surface of the gas-sensitive layer (15) not occupied by the dielectric layer (11) is covered by a catalytically active layer (16), and that the gas-sensitive layer (15) and the catalytically active layer (16) form the proposed layered composite.

The invention relates to a layered composite having a gas-sensitive layer and a catalytically active layer, and to a micromechanical sensor element, in particular a gas sensor element, having such a layered composite, as generically defined by the preambles to the independent claims.

### PRIOR ART

For measuring ingredients in such traffic-associated exhaust gases as carbon monoxide, hydrocarbons (CHₓ), nitrogen oxides (NOₓ) and so forth, semiconductor sensors are often used, in particular semiconductor sensors based on tin dioxide, since they change their electrical resistance significantly in the presence of reducing or oxidizing gases.

In general, reducing gases act to lower resistance, while oxidizing gases increase resistance. In the presence of a mixed gas, both effects therefore often occur; that is, the resultant change in resistance is essentially the sum of the individual signals, with their arithmetic sign, so that the individual components of the gas can no longer be measured independently of one another.

One known possible way of measuring oxidizing gases, especially nitrogen oxides (NOₓ), is to use a catalytic converter, which oxidizes reducing gas components, such as carbon monoxide or hydrocarbons, into carbon dioxide and water, before the gases reach the actual gas-sensitive SnO₂ layer. In the case of conventional “thick-film” sensors, porous catalytically active layers that are printed on the SnO₂ layer are used for the purpose. These layers comprise aluminum oxide (Al₂O₃) as substrate material, with such catalytically active substances as platinum or palladium applied over it.

“Thick-film” sensors on micromechanically structured substrates are also known in the prior art; the thick films used are again based on SnO₂. Such micromechanical sensor elements have the advantage that they can be brought to operating temperature at low power and with a small time constant.

In detail, micromechanically structured foundation substrates are produced for this purpose and then are provided with an SnO₂ layer to a thickness range of several micrometers by a known method such as dispensing or ink-jet. After that, the chip obtained is then cut apart by sawing, which leads to a considerable mechanical load on the thick film applied. These mechanical loads until now have prevented the realization of an above-explained two-layer system on a micromechanical sensor element.

A summary of known micromechanical gas sensor elements and conventional thick-film sensors with micromechanically structured, self-supporting membranes on the basis of SnO₂ layers is provided by I. Simon et al, “Micromachined Metal Oxide Gas Sensors: Opportunities to Improve Sensor Performance”, Sensors and Actuators, B73 (2001), pages 1-26.

### ADVANTAGES OF THE INVENTION

The layered composite and the micromechanical sensor element having such a layered composite according to the invention have the advantage over the prior art that a catalytically active layer, materially intimately joined to the actual gas-sensitive layer, is provided that has the effect that the gas-sensitive layer is not exposed to reducing gas components from a gas applied to its outside. In particular, these gas components have previously already been oxidized in the catalytically active layer, or converted into a gas that can no longer be detected by the gas-sensitive layer or no longer influences its electrical conductivity.

To this extent, it is attained by means of the layered composite of the invention that the micromechanical sensor element of the invention, in operation as a gas sensor element, is now sensitive only to oxidizing gas components such as NOₓ, and that its output signal is not also dependent on reducing gas components.

In addition, the layered composite of the invention has the advantage that with it, for the first time, a two-layer system on a micromechanical sensor element can be attained. Until now, thick-film systems comprising a sensitive SnO₂ layer and a catalytically active layer could be created only on so-called “hybrid sensors”, that is, the aforementioned sensor elements with an SnO₂ layer and with a layer of the substrate material, aluminum oxide, applied over it and catalytic substances applied over that. On micromechanical sensor elements, such a layered arrangement could previously not be achieved, for reasons of mechanical stability.

Advantageous refinements of the invention will become apparent from the provisions recited in the dependent claims.

Because the catalytically active layer and the gas-sensitive layer now essentially comprise the same gas-sensitive material or the same material basis, namely preferably SnO₂, and the composition of the gas-sensitive layer and of the catalytically active layer differ essentially only in the higher electrical conductivity of the gas-sensitive layer that can be attained by the addition of a dopant and the catalytic activity of the catalytically active layer that is attained by the addition of a catalytically active additive, the mechanical bond between these two thick films is very strong and intimate.

As a result, these two layers after being joined, for instance by a temperature treatment such as firing or sintering, behave mechanically like a single-layer system, yet the electrical and chemical advantages of a two-layer system, that is, the separation of the functions of “catalytic activity” and “gas sensitivity”, continue to be preserved. In particular, the layered composite and the micromechanical sensor element produced with it are relatively insensitive to mechanical stresses; that is, the sensor element is compatible with the established production technique for micromechanical gas sensors and can be produced with it.

It is also advantageous if the gas-sensitive layer has a thickness of 1 μm to 5 μm, and the catalytically active layer has a thickness of 1 μm to 10 μm.

Moreover, the electrical conductivity of the catalytically active layer should be as low as possible; that is, the catalytically active layer should have a substantially higher specific electrical resistance than the actually gas-sensitive layer. In this way, changes in the electrical conductivity of the catalytically active layer from fluctuating compositions of the applied gas have only a slight effect on the total resistance of the sensor element or layered composite.

Finally, it is advantageous if the catalytically active layer covers the gas-sensitive layer at least on one side, since in this way it is achieved that every gas acting on the gas-sensitive layer is first diffused through the catalytically active layer before reaching the gas-sensitive layer. Thus the gas-sensitive layer is not exposed, or at least is virtually not exposed, to reducing gases.

### DRAWINGS

The invention will be described in further detail in conjunction with the drawing and the ensuing description. The drawing is a basic sketch in section of a micromechanical gas sensor element with a self-supporting membrane and applied over it a layered composite with a gas-sensitive layer and a catalytically active layer.

Exemplary Embodiments

FIG. 1 shows a micromechanical sensor element 5, such as a gas sensor element or an air quality sensor element. To that end, first a dielectric layer 11 has been precipitated onto a supporting body 10, and then from the back side of the supporting body 10, a cavern 17 that extends as far as the dielectric layer 11 has been etched into the supporting body, creating a largely self-supporting membrane 18.

The supporting body 10 is for instance a silicon body, while the dielectric layer is for instance a silicon oxide layer, a silicon nitride layer, or a layer of porous silicon.

The dielectric layer 11 furthermore has conventional heating elements 13 for heating a gas-sensitive layer 15, applied to the dielectric layer 11 in the region of the membrane 18, and temperature sensor elements 12, with which the temperature of the gas-sensitive layer 15 can be ascertained.

Finally, electrodes 14 are disposed on the surface of the dielectric layer 11, spaced apart from one another, and each of them is joined to the gas-sensitive layer 15, so that by way of these electrodes 14 and electronic components, not shown, joined to them, the change in the electrical conductivity of the gas-sensitive layer 15 can be ascertained as a function of gas components applied to the outside.

In the example explained, the gas-sensitive layer 15 comprises a porous thick film of SnO₂, with a thickness of between 1 μm and 5 μm, which is provided in a known way with dopants such as tantalum to increase the electrical conductivity. The specific electrical resistance of the gas-sensitive layer 15 is between 50 kQcm and 200 kQcm, in particular approximately 100 kQcm.

The gas-sensitive layer 15 is also covered in such a way by a catalytically active layer 16 that the gas-sensitive layer 15 is enclosed by the dielectric layer 11 and the catalytically active layer 16.

In the example explained, the catalytically active layer 16 comprises the same material, or the same material basis, as the gas-sensitive layer 15, or in other words essentially comprises SnO₂, with the distinction that the catalytically active layer 16 is not exposed to a dopant that increases the electrical conductivity, and that the catalytically active layer 16 instead contains a catalytically active additive, such as platinum or palladium. The specific electrical resistance of the catalytically active layer 16 is greater than 300 kQcm, in particular greater than 500 kQcm.

The gas-sensitive layer 15 and the catalytically active layer 16 are intimately bonded to one another, so that they behave mechanically like a single layer, because of their virtually identical composition.

Aside from the catalytically active layer 16, the micromechanical sensor element 5 is otherwise known from I. Simon et al, Sensors and Actuators, B73 (2001), pp. 1-26, and above all FIG. 4 and FIGS. 8 and 9 thereof. From this reference, still other details on the construction of the micromechanical sensor element 5 and its production and function can be learned, so there is no need to show this aside from the production of the layered composite from the gas-sensitive layer 15 and the catalytically active layer 16.

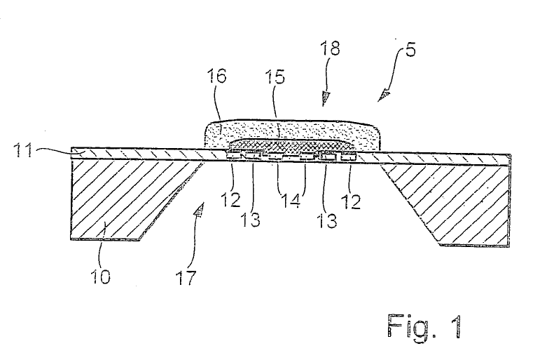

For realizing the layered composite from the gas-sensitive layer 15 and the catalytically active layer 16 of FIG. 1, it is provided that first high-purity SnO₂ powder is produced from aqueous solution. A first portion of this SnO₂ powder is then provided with the aforementioned dopants for increasing the electrical conductivity, while the largest possible quantity of catalytically active substances such as platinum and/or palladium is added to a second portion of the SnO₂ powder. Suitable preparation methods for this are known from the prior art.

Next, these two starting powders, of different composition from one another, are then applied, in the form of a first starting layer and a second starting layer, to the surface of the dielectric layer 11 of FIG. 1. In an ensuing temperature treatment, especially firing or sintering, the first starting layer is then converted into the gas-sensitive layer 15, and the second starting layer is converted into the catalytically active layer 16.

Conventional methods such as screen printing, dispensing, or inkjet are suitable for applying the first starting layer and the second starting layer located over it.

1-15 cancelled.

16. A layered composite, comprising a gas-sensitive layer; a catalytically active layer joined materially to said gas-sensitive layer at least in some regions, said gas-sensitive layer having a first material, said catalytically active layer having both said first material and a catalytically active additive, said catalytically active layer having a specific electrical resistance which is higher than a specific electrical resistive of said gas-sensitive layer, said gas-sensitive layer being sensitive to oxidizing gases, and said catalytically active layer oxidizing reducing gases.

17. The layered composite as defined in claim 16, wherein said gas-sensitive layer is sensitive to NOₓ.

18. The layered composite as defined in claim 16, wherein said catalytically active layer is composed of a material selected from the group consisting of CO and CHₓ.

19. The layered composite as defined in claim 16, wherein said gas-sensitive layer and said catalytically active layer are disposed such that each gas acting on said gas-sensitive layer is first diffused through said catalytically active layer before it reaches said gas-sensitive layer.

20. The layered composite as defined in claim 16, wherein said gas-sensitive layer and said catalytically active layer are disposed such that said gas-sensitive layer is at least nearly not exposed to reducing gasses.

21. The layered composite as defined in claim 16, wherein said gas-sensitive layer comprises the first material and dopants that increase its electrical conductivity, and said catalytically active layer comprises the first material and materials that enhance or initiate its catalytical activity.

22. The layered composite as defined in claim 21, wherein said first material is SnO₂.

23. The layered composite as defined in claim 21, wherein the materials that enhance or initiate the catalytic activity of said catalytically active layer are such materials which enhance or initiate the catalytic activity of said catalytically active layer to gasses that reduce oxidation.

24. The layered composite as defined in claim 21, wherein the materials that enhance or initiate the catalytic activity of said catalytically active layer are materials selected from the group consisting of platinum and palladium.

25. The layered composite as defined in claim 21, wherein said gas-sensitive layer and said catalytically active layer are porous.

26. The layered composite as defined in claim 16, wherein said gas-sensitive layer has a thickness of 1 μm to 5 μm, while said catalytically active layer has a thickness of 1 μm to 10 μm.

27. The layered composite as defined in claim 16, wherein said catalytically active layer has an electrical conductivity which is so much lower than an electrical conductivity of an gas-sensitive layer that a change of a conductivity of said catalytically active layer under an influence of a gas causes only a negligible change in a total resistance of the layered composite.

28. The layered composite as defined in claim 16, wherein said catalytically active layer covers said gas-sensitive layer an at least one side.

29. A micromechanical gas sensor element, comprising a dielectric layer; a gas-sensitive layer layer disposed on said dielectric layer; and means for detecting a change in an electrical conductivity of said gas-sensitive layer under an influence of a gas, in which a surface of said gas-sensitive layer not occupied by said dielectric layer is covered by a catalytically active layer, said gas-sensitive layer and said catalytically active layer forming a layered composite including the gas-sensitive layer and the catalytically active layer joined materially to said gas-sensitive layer at least in some regions, said gas-sensitive layer having a first material, said catalytically active layer having both said first material and a catalytically active additive, said catalytically active layer having a specific electrical resistance which is higher than a specific electrical resistance of said gas-sensitive layer, said gas-sensitive layer being sensitive to oxidizing gases, and said catalytically active layer oxidizing reducing gases.

30. The micromechanical gas sensor element as defined in claim 29, wherein said means include at least two electrodes which are spaced from one another and joined electrically conductively to said gas-sensitive layer.

31. The micromechanical gas sensor element as defined in claim 29; and further comprising at least one heating element for heating said at least one gas-sensitive layer.

32. The micromechanical gas sensor element as defined in claim 29; and further comprising at least one additional element selected from the group consisting of at least one heating element for heating at least said gas-sensitive layer, at least one temperature sensor element for ascertaining at least a temperature of said gas-sensitive layer, and both.

33. The micromechanical gas sensor element as defined in claim 29, wherein said dielectric layer is formed in some regions as a self-supporting membrane, said layered composite in the region of said self-supporting membrane being disposed on said dielectric layer and materially bonded to it.
